(19) United States
(12) Patent Application Publication
(10) Pub. No.: US 2025/0037369 A1
(43) Pub. Date: Jan. 30, 2025

(54) MESSAGE PREVIEW IN VIRTUAL ENVIRONMENT

(71) Applicant: TENCENT TECHNOLOGY (SHENZHEN) COMPANY LIMITED, Shenzhen (CN)

(72) Inventor: Teng CHEN, Shenzhen (CN)

(73) Assignee: TENCENT TECHNOLOGY (SHENZHEN) COMPANY LIMITED, Shenzhen (CN)

(21) Appl. No.: 18/914,701

(22) Filed: Oct. 14, 2024

Related U.S. Application Data
(63) Continuation of application No. PCT/CN2023/112897, filed on Aug. 14, 2023.

(30) Foreign Application Priority Data
Sep. 14, 2022 (CN) 202211113944.0

(51) Int. Cl. G06T 17/00; H04L 51/04; H04L 51/224

(52) U.S. Cl. CPC G06T 17/00; H04L 51/04; H04L 51/224

(57) ABSTRACT

In a method for previewing messages in a virtual environment, a plurality of virtual characters is displayed in the virtual environment. Each virtual character of the plurality of virtual characters is movable in the virtual environment. When a message is received from a first virtual character of the plurality of virtual characters, a message notification graphical element in association with the first virtual character is displayed in the virtual environment. Content of the received message is displayed in response to detecting a user input on the message notification graphical element. Apparatus and non-transitory computer-readable storage medium counterpart embodiments are also contemplated.

### RELATED APPLICATIONS

The present application is a continuation of International Application No. PCT/CN2023/112897, filed on Aug. 14, 2023, which claims priority to Chinese Patent Application No. 202211113944.0, filed on Sep. 14, 2022. The entire disclosures of the prior applications are hereby incorporated by reference.

### FIELD OF THE TECHNOLOGY

This application relates to computer technologies and human-computer interaction technologies, including a message preview in a virtual social scene.

### BACKGROUND OF THE DISCLOSURE

With the development of computer technologies, an electronic device may implement richer and more vivid virtual social scenes. A user may engage in chat and interaction with a virtual image of another user in a virtual social scene based on a virtual image of the user.

In the related art, when the user receives a message transmitted from another virtual image, a prompt of an unread message is provided. The user needs to tap an unread message item to perform a page jump to a chat details page to view content of the unread message, reducing human-computer interaction efficiency, and the human-computer interaction efficiency is further reduced by performing a plurality of page jumps to view messages transmitted from a plurality of virtual images.

### SUMMARY

Embodiments of this disclosure include a method, apparatus, and a non-transitory computer-readable storage medium for message preview in a virtual social scene to improve human-computer interaction efficiency and utilization of a hardware processing resource and a display resource of the device.

Examples of technical solutions in the embodiments of this disclosure may be implemented as follows:

An aspect of this disclosure provides a method for previewing messages in a virtual environment. A plurality of virtual characters is displayed in the virtual environment. Each virtual character of the plurality of virtual characters is movable in the virtual environment. When a message is received from a first virtual character of the plurality of virtual characters, a message notification graphical element in association with the first virtual character is displayed in the virtual environment. Content of the received message is displayed in response to detecting a user input on the message notification graphical element.

An aspect of this disclosure provides an apparatus, including processing circuitry. The processing circuitry is configured to display a plurality of virtual characters in a virtual environment. Each virtual character of the plurality of virtual characters is movable in the virtual environment. The processing circuitry is configured to display a message notification graphical element in association with the first virtual character in the virtual environment when a message is received from a first virtual character of the plurality of virtual characters. The processing circuitry is configured to display content of the received message in response to a detection of a user input on the message notification graphical element.

An aspect of this disclosure provides a non-transitory computer-readable storage medium storing instructions which when executed by a processor cause the processor to perform any of the methods of this disclosure.

Technical solutions provided in the embodiments of this disclosure can have the following beneficial effects:

In embodiments of this disclosure, in a virtual social scene, when a message transmitted by a virtual image is received, a message preview operation is performed on a message prompt control, so that displaying the message prompt control can be switched to displaying content of an unread message in a page of the current virtual social scene. In this way, compared with a manner, in the related art, in which a page jump is performed to view a message, embodiments of this disclosure improve message viewing efficiency in the virtual social scene, and reduce a quantity of times that human-computer interaction is performed to view the message, improving human-computer interaction efficiency. The message preview operation is implemented based on the message prompt control, so that there is no need to additionally occupy a display resource of a terminal, improving utilization of the display resource of the terminal.

### BRIEF DESCRIPTION OF THE DRAWINGS

FIG. 1 is a schematic diagram of viewing an unread message according to the related art.

FIG. 2 is a schematic diagram of an architecture of a message preview system 100 in a virtual social scene according to an embodiment of this disclosure.

FIG. 3 is a schematic diagram of a structure of an electronic device 500 implementing a message preview method in a virtual social scene according to an embodiment of this disclosure.

FIG. 4 is a schematic flowchart of a message preview method in a virtual social scene according to an embodiment of this disclosure.

FIG. 5 is a schematic diagram of a message preview interface according to an embodiment of this disclosure.

FIG. 6 and FIG. 7 each are a schematic diagram of displaying message content in a scrolling manner according to an embodiment of this disclosure.

FIG. 8 is a schematic diagram of a voice message preview interface according to an embodiment of this disclosure.

FIG. 9 is a schematic diagram of a group message preview interface according to an embodiment of this disclosure.

FIG. 10 and FIG. 11 each are a schematic flowchart of a message preview method in a virtual social scene according to an embodiment of this disclosure.

### DESCRIPTION OF EMBODIMENTS

To make the objectives, technical solutions, and advantages of this disclosure clearer, the following describes embodiments of this disclosure in further detail with reference to the accompanying drawings. The described embodiments are not to be considered as a limitation to embodiments of this disclosure. All other embodiments obtained by a person of ordinary skill in the art shall fall within the protection scope of this disclosure.

In the following descriptions, the term “some embodiments” describes a subset of all possible embodiments, but “some embodiments” may be a same subset or different subsets of all the possible embodiments, and can be combined with each other without a conflict.

In the following descriptions, the terms “first/second” are merely intended to distinguish between similar objects rather than describe a specific order of the objects. The terms “first/second” are interchanged in respect of a specific order or sequence if permitted, so that embodiments in this disclosure described herein can be implemented in an order other than the order illustrated or described herein.

Unless otherwise defined, meanings of all technical and scientific terms used in this specification are the same as those usually understood by a person skilled in the art to which this disclosure belongs. The descriptions of the terms are provided as examples only and are not intended to limit the scope of the disclosure.

Before embodiments of this disclosure are further described in detail, examples of nouns and terms in embodiments of this disclosure are described, and the nouns and the terms in embodiments of this disclosure are applicable to the following explanations.

(1) A client is an application program running in a terminal to provide various services, for example, a virtual social client, a game client, or an instant massaging client.

(2) The term “in response to” is configured for indicating a condition or a state on which to-be-performed operations depend. When the condition or the state on which the operations depend are met, one or more operations may be performed in real time or may be performed with a set delay. Unless otherwise specified, an execution order of the plurality of performed operations is not limited.

(3) A virtual social scene is a virtual scene displayed (or provided) when an application program runs on a terminal. The virtual scene may be a simulated environment of a real world, or a semi-simulated and semi-fictional virtual environment, or a purely fictional virtual environment. The virtual scene may be any one of a two-dimensional virtual scene, a 2.5-dimensional virtual scene, or a three-dimensional virtual scene. A dimension of the virtual scene is not limited in embodiments of this disclosure. For example, the virtual scene may include the sky, a land, and an ocean. The land may include environmental elements such as a desert or a city.

A user customizes a two-dimensional or three-dimensional virtual image (that is, a humanoid model) of the user, so that the user uses the virtual image of the user to engage in interaction such as social chat and task execution with a virtual image of another person in a virtual social scene.

(4) Virtual reality (VR) is computer-generated simulation of an environment (for example, a three-dimensional environment), with which a user may interact in a seemingly real or physical manner. VR may be a virtual reality system of a single device or a group of devices. For example, the simulation may be generated on a virtual reality helmet or some other display devices to display to a user. The simulation may include an image, a sound, a haptic feedback, and other simulated sensations in a real or fictional environment.

(5) A virtual image is an image of people and things with which interaction may be performed in a virtual scene, or a movable image in the virtual scene. The movable image may be a virtual character, a virtual animal, a cartoon character, or the like. For example, a character, an animal, a plant, an oil barrel, a wall, and a rock are displayed in the virtual scene. The virtual image may be a virtual image configured for representing the user in the virtual scene. The virtual scene may include a plurality of virtual images, and each virtual image has a shape and a volume in the virtual scene. This occupies a part of space in the virtual scene.

For example, the virtual image may be a user character controlled by an operation on the client, may be artificial intelligence (AI) that is set through training in a combat in the virtual scene, or may be a non-player character (NPC) that is set in interaction in the virtual scene. A quantity of virtual images in the virtual scene that participate in the interaction may be preset, or may be dynamically determined based on a quantity of clients that participate in the interaction.

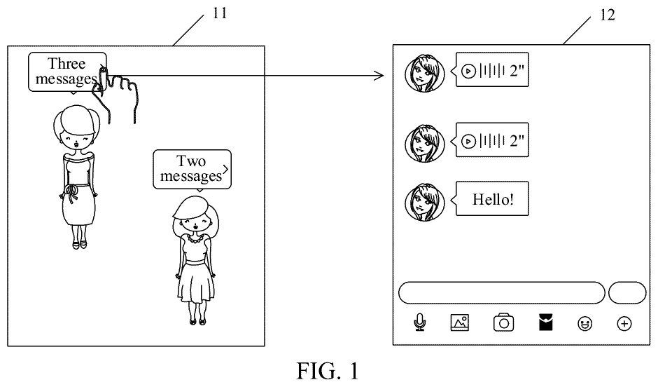

FIG. 1 is a schematic diagram of viewing an unread message according to the related art. Refer to FIG. 1. In a page 11 of a virtual social scene, when a message transmitted from another virtual image is received, a prompt of an unread message is provided. The prompt includes a quantity of unread messages. When a user taps an unread message item, a page jump is performed to a chat details page 12, to view all messages including a new message and a historical message in the chat details page 12. In this solution, to view content of a message, the user needs to tap the message to open a chat details page. In this case, the user leaves a virtual square scene, and an operation is added to return to the virtual square scene from the chat details page. The user may not intend to reply to some information or immediacy of some information is not high, but a details page needs to be entered for determining. This is inefficient. After tapping to enter the chat details page, the user needs to distinguish between information that is newly transmitted and old information. If a message transmitting interval is short, it is difficult to distinguish between the information, reducing message viewing efficiency in the virtual social scene, and a plurality of human-computer interaction operations are performed for viewing, resulting in low human-computer interaction efficiency.

Based on this, embodiments of this disclosure provide a message preview system, method, and apparatus in a virtual social scene, an electronic device, a computer-readable storage medium, and a computer program product, to improve message viewing efficiency and human-computer interaction efficiency in the virtual social scene. Details are provided below separately.

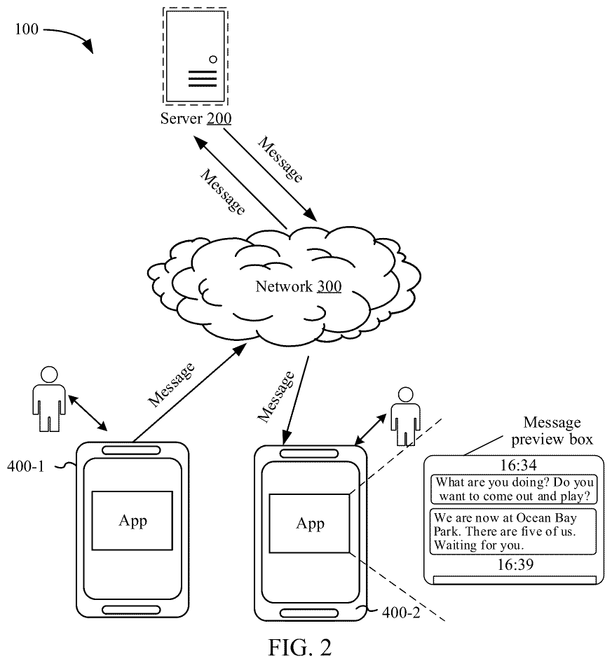

Based on the foregoing explanations of the nouns and the terms in embodiments of this disclosure, the message preview system in a virtual social scene provided in embodiments of this disclosure is first described. FIG. 2 is a schematic diagram of an architecture of a message preview system 100 in a virtual social scene according to an embodiment of this disclosure. To support an example application, a terminal 400 (where a terminal 400-1 and a terminal 400-2 are shown as an example) is connected to a server 200 through a network 300. The network 300 may be a wide area network or a local area network, or a combination thereof. Data transmission is implemented through a wireless or wired link.

The terminal 400-1 is configured to display at least two virtual images in a page of the virtual social scene.

The virtual image is capable of moving in the virtual social scene, and the virtual image is capable of changing a relative positional relationship with another virtual image when moving in the virtual social scene.

The server 200 is configured to: when the terminal 400-2 corresponding to a target virtual image transmits a message to a virtual image corresponding to the terminal 400-1, forward the message to the terminal 400-1.

The terminal 400-1 is further configured to: when receiving the message transmitted by the terminal 400-2 and forwarded by the server 200, display, in a target orientation of the target virtual image in the virtual social scene, a message prompt control configured to indicate that there is an unread message; and in response to a message preview operation on the message prompt control, switch displaying the message prompt control to displaying content of the unread message in the target orientation of the target virtual image.

In some embodiments, the message preview method in a virtual social scene provided in embodiments of this disclosure may be implemented by various electronic devices or computer devices, for example, may be independently implemented by a terminal, or may be independently implemented by a server, or may be implemented by a terminal and a server cooperatively. Embodiments of this disclosure may be applied to various scenarios, including but not limited to, instant messaging, a cloud technology, artificial intelligence, intelligent transportation, assisted driving, a game, a meta-universe, and the like.

In some embodiments, the electronic device implementing the message preview method in a virtual social scene provided in embodiments of this disclosure may be various types of terminals or servers. The server (for example, the server 200) may be an independent physical server, or may be a server cluster or a distributed system including a plurality of physical servers, or may be a cloud server that provides a cloud service, a cloud database, cloud computing, a cloud function, cloud storage, a network service, cloud communication, a middleware service, a domain name service, a security service, a content delivery network (CDN), big data, an artificial intelligence platform, and other basic cloud computing services. The terminal (for example, the terminal 400-1 or the terminal 400-2) may be a smartphone, a tablet computer, a notebook computer, a desktop computer, a smart voice interaction device (for example, a smart speaker), a smart home appliance (for example, a smart television), a smartwatch, a vehicle-mounted terminal, a VR device, or the like, but is not limited thereto. The terminal and the server may be directly or indirectly connected in a wired or a wireless communication manner. This is not limited in embodiments of this disclosure.

In some embodiments, the terminal or the server may implement the message preview method in a virtual social scene provided in embodiments of this disclosure by running a computer program. For example, the computer program may be a native program or a software module in an operating system, a native application (APP), that is, a program that needs to be installed in the operating system for running, an applet, that is, a program that only needs to be downloaded to a browser environment for running, or an applet that can be embedded into any APP. In summary, the foregoing computer program may be an application program, a module, or a plugin in any form.

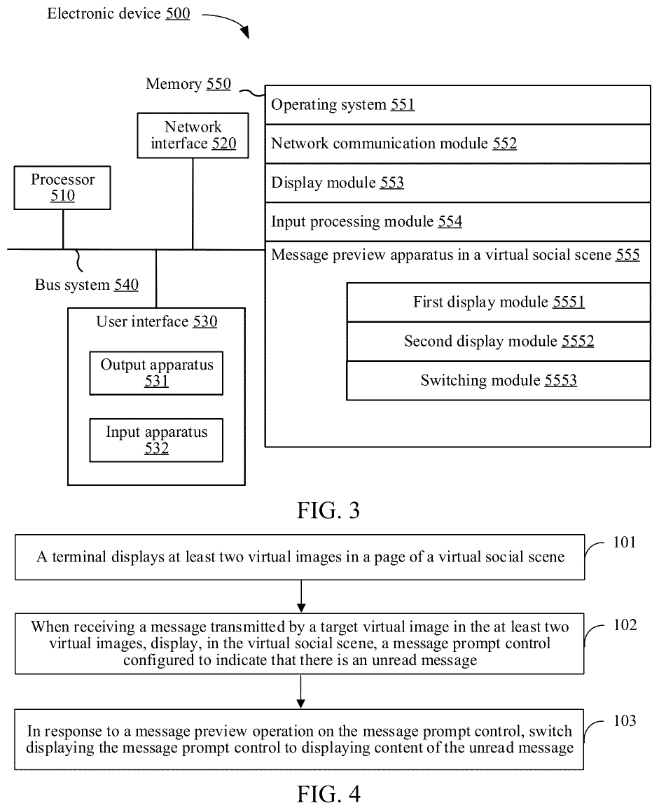

The following describes the electronic device implementing the message preview method in a virtual social scene provided in embodiments of this disclosure. FIG. 3 is a schematic diagram of a structure of an electronic device 500 implementing a message preview method in a virtual social scene according to an embodiment of this disclosure. An example in which the electronic device 500 is the terminal shown in FIG. 2 is used. The electronic device 500 provided in this embodiment of this disclosure includes: at least one processor 510 (e.g., processing circuitry), a memory 550 (e.g., a non-transitory computer-readable storage medium), at least one network interface 520, and a user interface 530. Components in the electronic device 500 are coupled together through a bus system 540. The bus system 540 is configured to implement connections and communication among these components. The bus system 540 further includes a power bus, a control bus, and a status signal bus in addition to a data bus. However, for clear description, various buses in FIG. 3 are all marked as the bus system 540.

The processor 510 may be an integrated circuit chip having a signal processing capability, for example, a general-purpose processor, a digital signal processor (DSP) or another programmable logic device, a discrete gate or a transistor logic device, or a discrete hardware component. The general-purpose processor may be a microprocessor, any conventional processor, or the like.

The user interface 530 includes one or more output apparatuses 531 that can present media content, and the output apparatus includes one or more speakers and/or one or more visual display screens. The user interface 530 further includes one or more input apparatuses 532, and the input apparatus includes a user interface component that facilitates inputting of a user, for example, a keyboard, a mouse, a microphone, a touch display screen, a camera, and other input buttons and controls.

The memory 550 may be removable, non-removable, or a combination thereof. For example, a hardware device includes a solid-state memory, a hard disk drive, or an optical disc drive. The memory 550 may include one or more storage devices that are physically away from the processor 510.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in embodiments of this disclosure aims to include any suitable type of memories.

In some embodiments, the memory 550 can store data to support various operations. Examples of the data include a program, a module, and a data structure or a subset or a superset thereof. Descriptions are provided below by using examples.

An operating system 551 includes a system program configured to process various basic system services and execute hardware-related tasks, for example, a framework layer, a core library layer, and a driver layer, and is configured to implement various basic services and process hardware-based tasks.

A network communication module 552 is configured to reach another computing device through one or more (wired or wireless) network interfaces 520. For example, the network interface 520 includes: Bluetooth, Wi-Fi, and a universal serial bus (USB).

A display module 553 is configured to present information through one or more output apparatuses 531 (such as a display screen and a speaker) associated with the user interface 530 (for example, a user interface configured to operate a peripheral device and display content and information).

An input processing module 554 is configured to detect one or more user inputs or interaction operations from the input apparatus 532 and translate the detected inputs or interaction operations.

In some embodiments, the message preview apparatus in a virtual social scene provided in embodiments of this disclosure may be implemented in a software manner. FIG. 3 shows a message preview apparatus 555 in a virtual social scene that is stored in the memory 550. The apparatus may be software in a form of a program, a plugin, or the like, and includes the following software modules: a first display module 5551, a second display module 5552, and a switching module 5553. These modules are logical and may be combined in any manner or further split based on a function to be implemented. A function of each module is described below.

In some other embodiments, the message preview apparatus 555 in a virtual social scene provided in embodiments of this disclosure may be implemented in a hardware manner. For example, the message preview apparatus in a virtual social scene provided in embodiments of this disclosure may be a processor in a form of a hardware decoding processor, and is programmed to perform the message preview method in a virtual social scene provided in embodiments of this disclosure. For example, the processor in the form of the hardware decoding processor may use one or more application-specific integrated circuits (ASICs), a DSP, a programmable logic device (PLD), a complex programmable logic device (CPLD), a field programmable gate array (FPGA), or other electronic elements.

Based on the foregoing descriptions of the message preview system in a virtual social scene and the electronic device in embodiments of this disclosure, the following describes the message preview method in a virtual social scene provided in embodiments of this disclosure. In some embodiments, the message preview method in a virtual social scene provided in embodiments of this disclosure may be independently implemented by a server or a terminal, or implemented by a server and a terminal cooperatively. The following describes the message preview method in a virtual social scene provided in embodiments of this disclosure by using an example in which the method is implemented by the terminal.

FIG. 4 is a schematic flowchart of a message preview method in a virtual social scene according to an embodiment of this disclosure. The message preview method in a virtual social scene provided in this embodiment of this disclosure includes:

Operation 101: A terminal displays at least two virtual images in a page of the virtual social scene. For example, a plurality of virtual characters is displayed in the virtual environment.

During actual application, a client (for example, a social client or a game client) that supports the virtual social scene, or a client (for example, an instant messaging client, a live streaming client, or a recruiting client) that integrates with a virtual social scene function is installed on the terminal. For example, the instant messaging client that integrates with the virtual social scene function is provided on the terminal. When the instant messaging client runs the virtual social scene function, the terminal displays the page of the virtual social scene. A plurality of (that is, at least two) virtual images may be displayed in the page, and each virtual image corresponds to one user object. The virtual image is capable of moving in the virtual social scene, and the virtual image is capable of changing a relative positional relationship with another virtual image when moving in the virtual social scene. A user may engage in a messaging session with another virtual image in the virtual social scene based on a virtual image corresponding to the user. The virtual image herein may be a three-dimensional virtual image or a two-dimensional virtual image, and the another virtual image may be a virtual image of a friend in a buddy list of the current user, or any virtual image entering the virtual social scene. That is, in the virtual social scene, a relationship between the virtual image and a virtual image corresponding to a current login account (that is, the current user) may be a friend relationship or a non-friend relationship. When a relationship between a target virtual image and the virtual image of the current login account is a non-friend relationship, the virtual image of the current login account may be controlled to perform a target operation related to the target virtual image, to establish a friend relationship with the target virtual image. For example, the target operation may be a high-five operation between the virtual image and the target virtual image.

An example in which a virtual social client is provided on the terminal is used. When the user opens and runs the virtual social client on the terminal, the user may set the virtual image of the user based on the social client. Specifically, in a virtual image setting interface, the user may autonomously edit the virtual image of the user, for example, select a two-dimensional or three-dimensional model, or select an apparel, to edit the virtual image of the user, and interact, for example, chat or cooperatively complete a task, with a virtual image of another user in the virtual social scene based on an edited virtual image.

During actual application, in the virtual social scene, in addition to a virtual image of a single user, a virtual group image corresponding to a social group can be presented. The user may engage in a messaging session with another virtual image in the social group in the virtual social scene based on the virtual image corresponding to the user and the virtual group image.

In some embodiments, in the virtual social scene, the terminal also displays a state of each virtual image. The state is configured for indicating an operation currently performed by the virtual image. For example, a chat state configured for indicating that the virtual image is chatting is displayed, or a listening to music state configured for indicating that the virtual image is listening to music is displayed. In this way, other users can learn of the state of the virtual image, facilitating interaction between virtual images.

Operation 102: When receiving a message transmitted by a target virtual image in the at least two virtual images, display, in the virtual social scene, a message prompt control configured to indicate that there is an unread message. For example, when a message is received from a first virtual character of the plurality of virtual characters, a message notification graphical element in association with the first virtual character is displayed in the virtual environment.

In some embodiments, in the virtual social scene, the message prompt control configured to indicate that there is the unread message is displayed. That is, the message prompt control configured to indicate that there is the unread message is displayed in a target orientation of the target virtual image in the virtual social scene. The target orientation may be any position, in three-dimensional space, that is centered around the target virtual image and whose distance from the target virtual image is a target distance. For example, the target orientation is a position that is above the target virtual image and whose distance from the top of a head is a first length, or a position that is on the left of the target virtual image and whose distance from a left arm is a second length.

When the target virtual image in the virtual social scene transmits a message to the virtual image of the current user, in the target orientation of the target virtual image, the message prompt control (that is, a message prompt button or a message prompt function item) configured to indicate that there is an unread message is displayed. The message prompt control further indicates a quantity of unread messages. That is, the message prompt control further carries text information configured for indicating count of the unread message. When the user taps the message prompt control, the terminal jumps to a message details page from the page of the virtual social scene, and displays content of the unread message in the message details page. When there is a historical session between the target virtual image and the current virtual image, the terminal further displays historical chat content between the target virtual image and the current virtual image in the message details page.

In some embodiments, the message prompt control is associated with the target virtual image. To be specific, the relative positional relationship remains unchanged, and when the target virtual image moves in the virtual social scene, the terminal displays a process in which the message moves synchronously with the target virtual image, in other words, the message prompt control moves synchronously with the target virtual image.

Operation 103: In response to a message preview operation on the message prompt control, switch displaying the message prompt control to displaying content of the unread message. For example, content of the received message is displayed in response to detecting a user input on the message notification graphical element.

During actual application, the message preview operation is configured for indicating to preview the unread message, in other words, indicating to browse the content of the message in advance.

In some embodiments, displaying message prompt control is switched to displaying the content of the unread message. In other words, displaying the message prompt control is switched to displaying the content of the unread message in the target orientation of the target virtual image. The message preview operation may be a press operation on the message prompt control. Correspondingly, in response to the message preview operation on the message prompt control, the terminal may switch displaying the message prompt control to displaying the content of the unread message in the target orientation of the target virtual image in the following manner: When determining that the press operation on the message prompt control meets a message preview condition, the terminal cancels displaying the message prompt control, and in a process of performing the press operation, the terminal displays the content of the unread message in the target orientation of the target virtual image; and when the press operation is released, the terminal cancels displaying the content of the unread message, and displays the message prompt control again in the target orientation of the target virtual image.

According to the foregoing embodiment, in this way, the content of the unread message is previewed in the page of the current virtual social scene, without requiring the terminal to perform a page jump to a chat details page. This improves efficiency of viewing the content of the message and ensures that the user does not miss information in the virtual social scene in a process of previewing the content of the message. In addition, the message preview operation is implemented based on the message prompt control, so that a display resource of the terminal does not need to be additionally occupied, improving utilization of the display resource of the terminal.

The message preview condition is described below. In some embodiments, when the user triggers the press operation on the message prompt control, the terminal detects press duration of the press operation, and when it is detected that the press duration reaches a duration threshold (where the duration threshold may be specifically set according to an actual situation, for example, set to 2 seconds), determines that the press operation meets the message preview condition. In some other embodiments, when the user triggers the press operation on the message prompt control, the terminal detects press pressure of the press operation, and when it is detected that a press pressure value reaches a pressure threshold (where the pressure threshold may be specifically set according to an actual situation), determines that the press operation meets the message preview condition. In some other embodiments, when the user triggers the press operation on the message prompt control, the terminal detects both press pressure and press duration of the press operation, and when it is detected that the press duration reaches a duration threshold and a press pressure value reaches a pressure threshold, determines that the press operation meets the message preview condition.

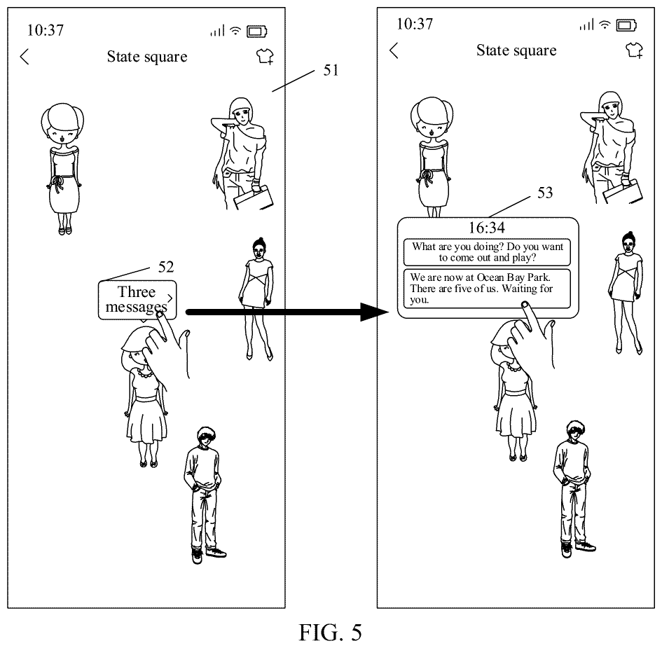

For example, FIG. 5 is a schematic diagram of a message preview interface according to an embodiment of this disclosure. Refer to FIG. 5. In a page 51 of a virtual social scene, virtual images of different users are displayed. Each user may control a virtual image corresponding to the user to perform an action, for example, walk or run, in the virtual social scene, and execute a task with another virtual image cooperatively. When a message transmitted by a target virtual image to the current virtual image in the virtual social scene is received, a message prompt control 52 configured to indicate that there is an unread message from the target virtual image is displayed in a target orientation of the target virtual image (for example, above the top of a head or at a target distance above a center of gravity of the body). When the user triggers a press operation on the message prompt control, the terminal detects press duration of the press operation. When the press duration reaches a duration threshold, the terminal is triggered to enter a message preview mode, and switches the originally displayed message prompt control to displaying content 53 of the unread message still in the target orientation of the target virtual image. When the press operation is released, the terminal switches displaying content of the unread message back to displaying the message prompt control.

In some embodiments, the message preview operation may be a trigger operation on the message prompt control. Correspondingly, in response to the message preview operation on the message prompt control, the terminal may switch displaying the message prompt control to displaying the content of the unread message in the target orientation of the target virtual image in the following manner: Displaying the message prompt control is canceled, and the content of the unread message is displayed in the target orientation of the target virtual image; and when display duration of the content reaches first duration, displaying the content of the unread message is canceled.

During actual application, when the user triggers the message preview operation, the content of the unread message may be displayed in the page of the current virtual social scene, and the content automatically disappears when the display duration reaches the first duration (where a specific value may be set according to an actual requirement, for example, set to 3 seconds), so that the user previews the content of the unread message. In this way, message viewing efficiency is improved, and the display resource of the terminal is fully utilized, improving the utilization of the display resource.

Since a single-tap operation on the message prompt control is configured for triggering a page jump to the chat details page, the trigger operation on the message prompt control may be any operation other than the single-tap operation on the message prompt control. For example, the message preview operation may be a double-tap operation or a drag operation on the message prompt control.

In some embodiments, the message preview operation may alternatively be a shake operation (for example, a shake operation) on the message prompt control. After the terminal displays the message prompt control configured to indicate that there is an unread message, the user holds the terminal to perform the shake operation, and the terminal determines the shake operation as a shake operation on the message prompt control. During actual application, the terminal may receive messages transmitted by a plurality of (at least two) virtual images. In the page of the virtual social scene, message prompt controls are respectively displayed in target orientations of the virtual image. In this way, when the user triggers the shake operation on the terminal, the terminal controls each message prompt control to be in a candidate state. In response to a user-triggered selection instruction for the message prompt control in the candidate state, displaying a selected message prompt control is switched to displaying content of a corresponding unread message in a target orientation of a virtual image to which the selected message prompt control corresponds. The selection instruction herein may be triggered by a trigger operation (for example, a single-tap operation or a double-tap operation) of the user for the message prompt control in the candidate state, or triggered by a voice instruction.

During actual application, the content of the unread message may be carried in a message preview box. Specifically, in response to the message preview operation on the message prompt control, the terminal may switch displaying the message prompt control to displaying the content of the unread message in the target orientation of the target virtual image in the following manner: The terminal cancels displaying the message prompt control; and displays a message preview box in the target orientation of the target virtual image, and displays the content of the unread message in the message preview box. The message preview box may be displayed through a floating layer or through a floating window.

According to the foregoing embodiment, the content of the unread message is uniformly displayed in the message preview box. This improves viewing efficiency of the content of the message and ensures that the user does not miss information in the virtual social scene in a process of previewing the content of the message. In this way, message viewing efficiency is improved, and the display resource of the terminal is fully utilized, improving the utilization of the display resource.

In some embodiments, a size of the message preview box can adapt to a quantity of current unread messages. For example, when there are a plurality of messages, to enable the user to view content of all unread messages at the same time, the terminal dynamically adjusts the size of the message preview box based on a size of a display area required for the content of the unread messages, so that the user can preview the content of the unread messages, and coverage of the content in a current page is minimized.

In some embodiments, a size of the message preview box is a fixed size. The terminal may display the content of the unread message in the message preview box in the following manner: When a display area required for the content of the unread message is not greater than a display area of the message preview box, the content of the unread message is directly displayed in the message preview box; or when a display area required for the content of the unread message is greater than a display area of the message preview box, the content of the unread message is displayed in the message preview box in a scrolling manner.

During actual application, with reference to the display area required for the content of the unread message and the display area of the message preview box, a display manner of the content of the unread message is determined. In this way, display flexibility in a process of displaying the unread message is improved, and the display resource of the terminal is also fully utilized, improving the utilization of the display resource.

The terminal may display, in a scrolling manner, the content of the unread message in the message preview box in the following manner: The terminal displays a first part of content of the unread message in the message preview box; the terminal scrolls the first part of content to cause the first part of content to gradually disappear from the message preview box; and the terminal gradually displays a second part of content of the unread message in a process of scrolling the first part of content, where receiving time of the second part of content is earlier than receiving time of the first preview box.

According to the foregoing embodiment, the user can first view content of a recently received unread message, and content of a historical unread message can be automatically displayed for the user in a scrolling manner, improving message preview experience of the user.

Herein, when the message preview operation is the press operation on the message prompt control, the displaying the content of the unread message in a scrolling manner may be circular scrolling display. To be specific, when all content of the unread message is presented through scrolling display, if the current user does not trigger a preview end instruction, that is, the press operation is not released, the first part of content and the second part of content of the unread message are circularly re-scrolled.

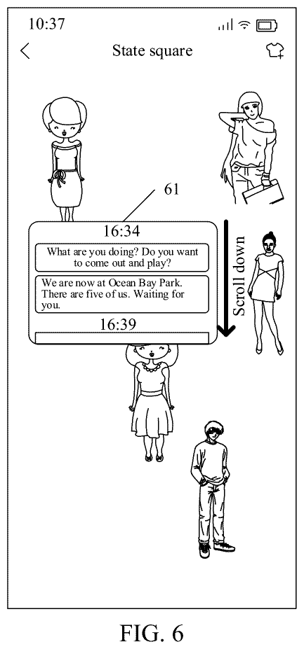

During actual application, with reference to the message preview box, a scrolling direction of the content of the unread messages may be a downward direction. FIG. 6 is a schematic diagram of displaying message content in a scrolling manner according to an embodiment of this disclosure. Refer to FIG. 6. With reference to a current preview box 61, content of unread messages is sequentially displayed in the preview box from top to bottom, and a display order is an ascending order of receiving time. When there are a large quantity of unread messages, and scrolling is required to display content of all unread messages, before displaying, in a scrolling manner, the content displayed in the preview box, the terminal displays content of at least one recently received unread message (having latest receiving time) in the preview box from top to bottom in ascending order of receiving time, and then scrolls the content of the unread message in the preview box from top to bottom to display content of an unread message whose receiving time is earlier than the receiving time of the message in the current preview box, that is, content of a historical unread message. In this way, an operation of the user sliding down a page to view the content of the historical message is simulated, so that the user does not need to scroll actively, and scrolling display of the unread message content is automatically performed, improving the message preview experience of the user.

Herein, each unread message displayed in the preview box may carry a receiving time stamp to indicate receiving time of the corresponding message. For two adjacent messages among the plurality of messages, if a difference between receiving time of the messages does not exceed a time threshold (where the time threshold may be set according to an actual requirement, for example, set to 1 minute), a new time stamp is not added. That is, a message having later receiving time in the two adjacent messages may not carry a time stamp.

In some embodiments, the message preview box only displays content of one unread message. When there are at least two unread messages, the terminal may display, in a scrolling manner, content of the unread message in the message preview box in the following manner: For a first unread message and a second unread message that are adjacent in receiving time in the at least two unread messages, content of the first unread message is displayed in the message preview box, and when display duration of the content of the first unread message reaches second duration (where a specific value may be set according to an actual requirement, for example, set to 2 seconds), the first unread message is controlled to move out of the message preview box and disappear; and when the first unread message is moved out of the message preview box, the second unread message is controlled to move in the message preview box, and content of the second unread message is displayed in the message preview box. During actual application, receiving time of the first unread message may be earlier than receiving time of the second unread message, and the message preview box may be displayed on a popover.

In this way, based on receiving time of a message, content of unread messages is sequentially presented in a pop-up pattern, enabling the user to preview the unread messages one by one. Since the message preview box displays only content of one unread message, small display space is occupied, and content in the virtual social scene presented in a current page is not greatly affected.

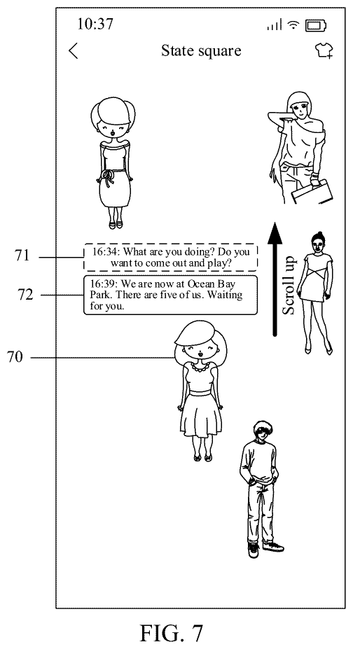

For example, FIG. 7 is a schematic diagram of displaying message content in a scrolling manner according to an embodiment of this disclosure. Refer to FIG. 7. When the user receives a message transmitted by a target virtual image 70 and the user triggers a message preview operation on an unread message, content of a message having earliest receiving time is displayed first in a message preview box above the top of a head of the target virtual image 70, and then when display duration of the message having the earliest receiving time reaches 2 seconds (the second duration), the message is moved out and a next unread message is moved in. As shown in FIG. 7, a message 71 and a message 72 are two unread messages that are adjacent in receiving time. In a preview and presentation process, the message 71 is displayed first, and when display duration of the message 71 reaches 2 seconds (the second duration), the message 71 is controlled to move out of the message preview box and disappear; and when the message 71 is moved out of the message preview box, the message 72 is controlled to move in the message preview box, and content of the message 72 is displayed in the message preview box.

In some embodiments, there is a case that the message received from the target virtual image is a voice message. For this case, the terminal may switch displaying the message prompt control to displaying the content of the unread message in the target orientation of the target virtual image in the following manner: The terminal cancels displaying the message prompt control, and when the unread message is an unread voice message, displays, in the target orientation of the target virtual image, a voice identifier of the unread voice message and text content obtained by performing text conversion on the unread voice message. In this way, the user does not need to manually perform a voice-to-text operation, facilitating previewing content of the unread voice message by the user.

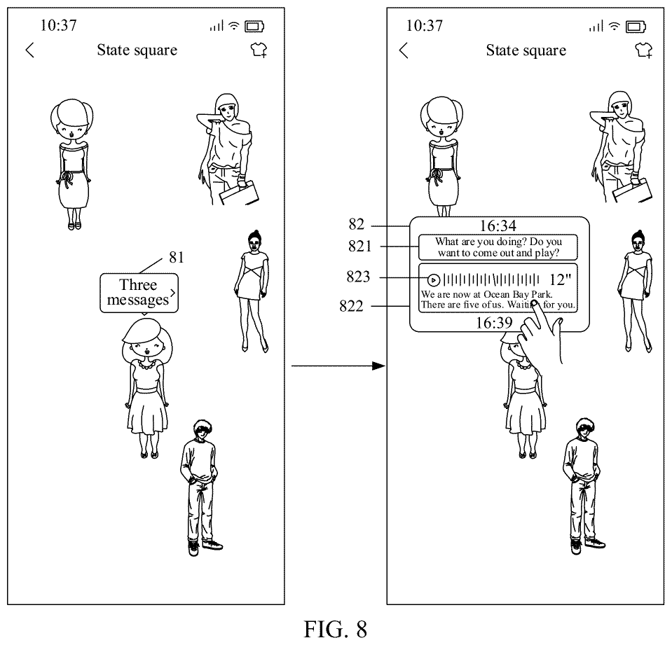

For example, FIG. 8 is a schematic diagram of a voice message preview interface according to an embodiment of this disclosure. Refer to FIG. 8. The user triggers preview of unread messages by performing the press operation on the message prompt control. When the unread messages include an unread text message and an unread voice message, the terminal cancels displaying a message prompt control 81, and displays a message preview box 82 in the target orientation of the target virtual image. The message preview box 82 displays content 821 of the unread text message and content 822 of the unread voice message. The content 822 of the unread voice message includes a voice identifier 823 of the unread voice message and text content obtained by performing text conversion on the unread voice message.

Herein, since the unread message is an unread voice message, to allow the user to perceive a sentiment of a voice sender, during actual application, the terminal may play voice content of the unread voice message in a process of displaying text content obtained by performing text conversion on the unread voice message. In this way, communication effectiveness of the user during chatting is improved, thereby improving human-computer interaction efficiency and hardware resource utilization of an electronic device.

In some embodiments, the page of the virtual social scene currently presented by the terminal does not include virtual images of all friends of the current user, in other words, includes only virtual images of a part of the friends of the user. For example, only a virtual image of a friend whose quantity of times of interaction with the current user reaches an interaction quantity threshold within a target time period (for example, one week) is presented, or a virtual image of a friend whose interaction frequency (a quantity of times of interaction in one day) with the current user reaches an interaction frequency threshold within a recent time period (for example, three days) is presented. Specifically, before the message transmitted by the target virtual image is received, at least one virtual image that does not include the target virtual image is displayed in the page of the virtual social scene; when a message transmitted by the target virtual image is received, the target virtual image is displayed in the page of the virtual social scene; and the target virtual object and the at least one virtual image are determined as the at least two virtual images. Based on this, before the message transmitted by the target virtual image is received, the target virtual image is not in the page of the current virtual social scene. When the message transmitted by the target virtual image is received, the target virtual image is displayed in the page of the virtual social scene, and the message prompt control configured to indicate that there is the unread message is displayed in the target orientation of the target virtual image. In this way, when the target virtual image is not in the page of the virtual social scene, the target virtual image is displayed in the page of the current virtual social scene, so that the user can learn of a transmitting object of the message. This fully utilizes the display resource of the terminal, and improves the utilization of the display resource.

In some embodiments, to enable the user to quickly reply to the unread message after the user browses the content of the unread message in the page of the virtual social scene, after switching displaying the message prompt control to displaying the content of the unread message, the terminal further displays a quick reply control for the unread message. The quick reply control is configured to quickly reply to the unread message. In this way, the user may quickly reply to the unread message based on the quick reply control, increasing a diversity of communication manners during chatting, and improving communication experience of the user, thereby improving the human-computer interaction efficiency and the hardware resource utilization of the electronic device.

During actual application, the quick reply control may be a voice quick reply control configured to make a voice quick reply. In response to a press operation on the voice quick reply control, when the press operation meets a trigger condition, the terminal performs audio capturing in a process of performing the press operation; and when the press operation is released, the terminal transmits a voice message including captured audio content to the target virtual image.

According to the foregoing embodiment, the voice quick reply is made through the quick reply control, not only increasing the diversity of communication manners during chatting and improving the communication experience of the user, but also improving the communication effectiveness of the user during chatting, thereby improving the human-computer interaction efficiency and the hardware resource utilization of the electronic device.

During actual application, the quick reply control may alternatively be a text quick reply control configured to make a text quick reply. In response to a trigger operation on the text quick reply control, the terminal displays a message transmitting box and a corresponding transmitting control; in response to a text editing operation, the terminal displays edited content in the message transmitting box; and in response to a message transmitting instruction triggered based on the transmitting control (for example, tapping the transmitting control), the terminal transmits the edited content to the target virtual image.

During actual application, text editing and message transmitting are implemented through the quick reply control, increasing the diversity of chat manners during chatting and improving the communication experience of the user, thereby improving the human-computer interaction efficiency and the hardware resource utilization of the electronic device.

In some embodiments, the virtual social scene further includes a virtual group image corresponding to at least one social group. Each social group corresponds to one virtual group image. The virtual group image is a three-dimensional image model configured to represent the corresponding social group. When receiving a message transmitted by a member in a target social group, the terminal displays, in a target orientation of a target three-dimensional image model corresponding to the target social group, a group message prompt control configured to indicate that there is an unread group message; and in response to a message preview operation on the group message prompt control, the terminal switches displaying the group message prompt control to displaying content of the unread group message in the target orientation of the target three-dimensional image model. In this case, the user previews the content of the unread group message through the group message prompt control. In this way, message viewing efficiency is improved, and the display resource of the terminal is fully utilized, improving the utilization of the display resource.

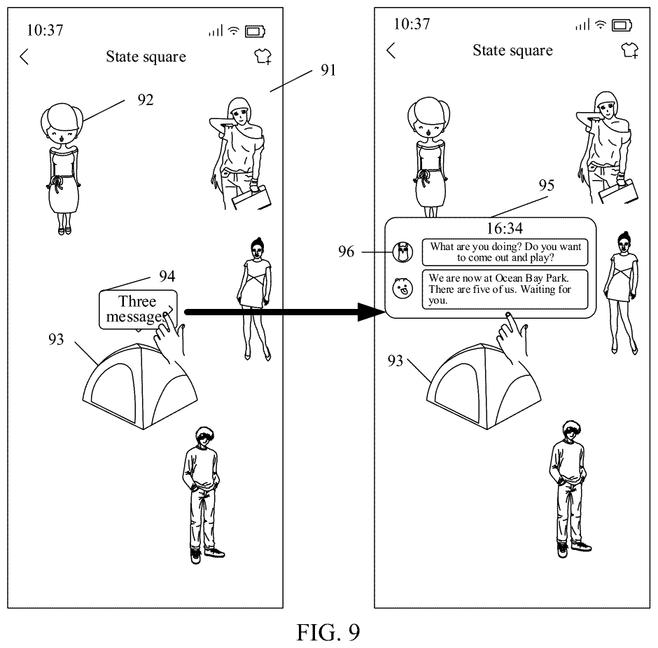

For example, FIG. 9 is a schematic diagram of a group message preview interface according to an embodiment of this disclosure. Refer to FIG. 9. In a page 91 of a virtual social scene, virtual images (such as a virtual image 92) of different users and a target three-dimensional image model 93 corresponding to a target social group are displayed. When receiving a message transmitted by a member in the target social group to a current virtual image, the terminal displays, in a target orientation (for example, at a target distance above) of the target three-dimensional image model 92, a message prompt control 94 configured to indicate that there is an unread message from the target social group. When the user triggers a press operation on the message prompt control 94, the terminal detects press duration of the press operation. When the press duration reaches a duration threshold, the terminal is triggered to enter a message preview mode, and switches the originally displayed message prompt control 94 to displaying content 95 of the unread message still in the target orientation of the target three-dimensional image model 93, where the content 95 of the unread message carries an object identifier 96 of the transmitting object. When the press operation is released, the terminal switches displaying the content of the unread message back to displaying the message prompt control.

In some embodiments, there is a case that the user may be busy interacting with another virtual image in the virtual social scene without noticing an unread message. In this case, if the target virtual image transmits a large quantity of messages to the current user, it is considered by default that the target virtual image has an urgent need to communicate with the current user by using a message. When a quantity of unread messages transmitted by the target virtual image reaches a quantity threshold, the terminal plays a message prompt audio, where the message prompt audio is configured for indicating to view the unread message transmitted by the target virtual image. In this way, the target virtual image can remind the user to view the message in time, avoiding missing an important message, improving the communication experience of the user, thereby improving the human-computer interaction efficiency and the hardware resource utilization of the electronic device.

In some embodiments, the virtual social scene may be a game scene. In the game scene, each virtual image corresponds to a game role. The user may combat with another virtual image in the game scene based on a virtual image of the user. For example, a virtual image of a current login account belongs to a first virtual camp, where the first virtual camp includes at least two virtual objects. A second virtual camp is in a hostile relationship with the first virtual camp including the at least two virtual objects. In a process in which the virtual image of the current login account combats with a virtual object in the second virtual camp, when a message transmitted by a target virtual image in the first virtual camp is received, a message prompt control configured to indicate that there is an unread message is displayed in a target orientation of the target virtual image in the game scene. In response to a message preview operation on the message prompt control, displaying the message prompt control is switched to displaying content of the unread message in the target orientation of the target virtual image. In this way, the user can have a quick review on a message from a teammate in the game scene by triggering the message preview operation, and have enjoyable and efficient social communication experience without affecting a game progress.

In some embodiments, the virtual social scene may alternatively be a virtual social scene based on virtual reality. That is, the virtual social scene is implemented based on a virtual reality technology. Correspondingly, an electronic device for displaying a page of the virtual social scene is a VR device, for example, a wearable VR device. The user may perceive the virtual social scene projected by the wearable VR device and interact with another user in the virtual social scene through the virtual social scene projected by the VR device. During actual application, the VR device displays at least two virtual images in the page of the virtual social scene. When a message transmitted by a target virtual image is received, a message prompt control configured to indicate that there is an unread message is displayed in a target orientation of the target virtual image in the virtual social scene. In response to a message preview operation on the message prompt control, displaying the message prompt control is switched to displaying content of the unread message in the target orientation of the target virtual image.

The message preview operation is described herein. In some embodiments, the message preview operation may be a somatosensory operation for triggering the message prompt control. When the somatosensory operation for triggering the message prompt control is detected, the somatosensory operation is determined as the message preview operation. For example, the somatosensory operation may be a virtual tapping operation on the message prompt control. The user wears a sensor glove that can locate a hand. When the user taps a position of a corresponding message prompt control in the virtual scene, the message preview operation is triggered. Alternatively, the user taps a position of a corresponding message prompt control in the virtual scene with a bare hand. A limb position of the user is detected, so that when it is determined that the user taps the position of the corresponding message prompt control in the virtual scene with a bare hand, the message preview operation is triggered.

In some other embodiments, the message preview operation may alternatively be a ray emitting operation on an external device. When the ray emitting operation on the external device is detected, and an irradiation position of a ray emitted by the external device corresponds to a target position based on the ray emitting operation, the ray emitting operation is determined as the message preview operation. The target position is a display position of the message prompt control in the virtual social scene. For example, the external device is a handle or a ring that can emit a ray (for example, laser light). In a process in which the VR device displays the message prompt control, when the user triggers a ray emitting operation based on the handle or the ring, and a ray emitted by the handle or the ring irradiates the target position, the ray emitting operation is determined as the message preview operation to trigger message preview.

Herein, when the ray emitting operation on the external device is detected, and the irradiation position of the ray emitted by the external device corresponds to the target position based on the ray emitting operation, duration during which the irradiation position of the ray corresponds to the target position, that is, duration during which the ray irradiates the message prompt control in the virtual scene, is obtained, and when the duration reaches a duration threshold (where the duration threshold may be specifically set according to an actual requirement, for example, set to 2 s), the ray emitting operation is determined as the message preview operation.

During actual application, when the virtual social scene is the virtual social scene based on virtual reality, the user can preview the content of the unread message based on the message prompt control. In this way, message viewing efficiency is improved, and the display resource of the terminal is fully utilized, improving the utilization of the display resource.

According to the foregoing embodiments of this disclosure, in a virtual social scene, when a message transmitted by a virtual image is received, a message preview operation is performed on a message prompt control, so that displaying the message prompt control can be switched to displaying content of an unread message in a page of the current virtual social scene. In this way, compared with a manner, in the related art, in which a page jump is performed to view a message, embodiments of this disclosure improve message viewing efficiency in the virtual social scene, and reduce a quantity of times that human-computer interaction is performed to view the message, improving human-computer interaction efficiency. The message preview operation is implemented based on the message prompt control, so that there is no need to additionally occupy a display resource of a terminal, improving utilization of the display resource of the terminal.

The following describes an example application of embodiments of this disclosure in an actual application scenario. In a scenario including a plurality of virtual roles (that is, the foregoing virtual image), a user receives a message transmitted from another user, and a prompt of an unread message is displayed at the top of a head of a role transmitting the message. The user long presses the message prompt, and the prompt changes to message preview, to display content of all unread new messages. If there is a voice message, a voice-to-text result is automatically displayed, facilitating previewing all messages by the user. Detailed descriptions are provided below.

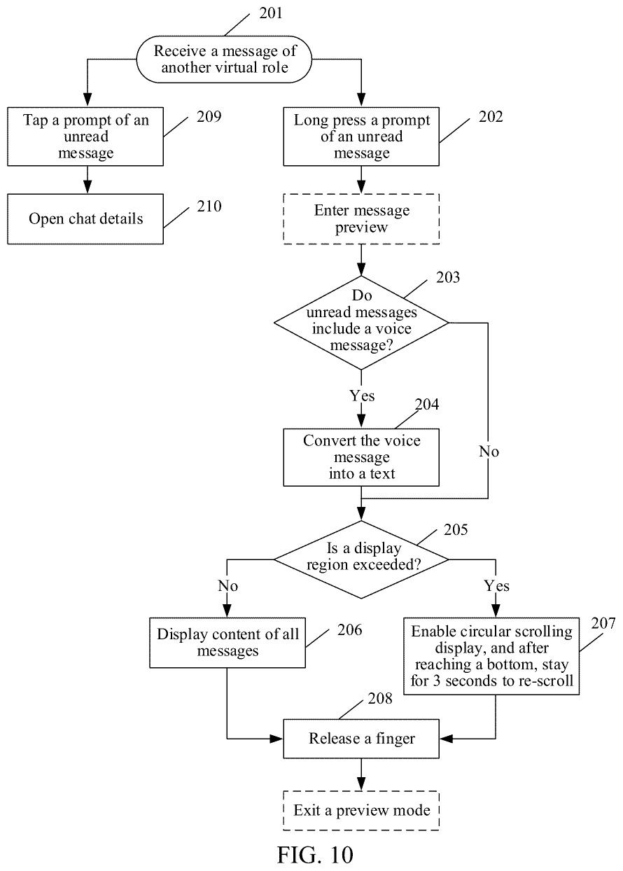

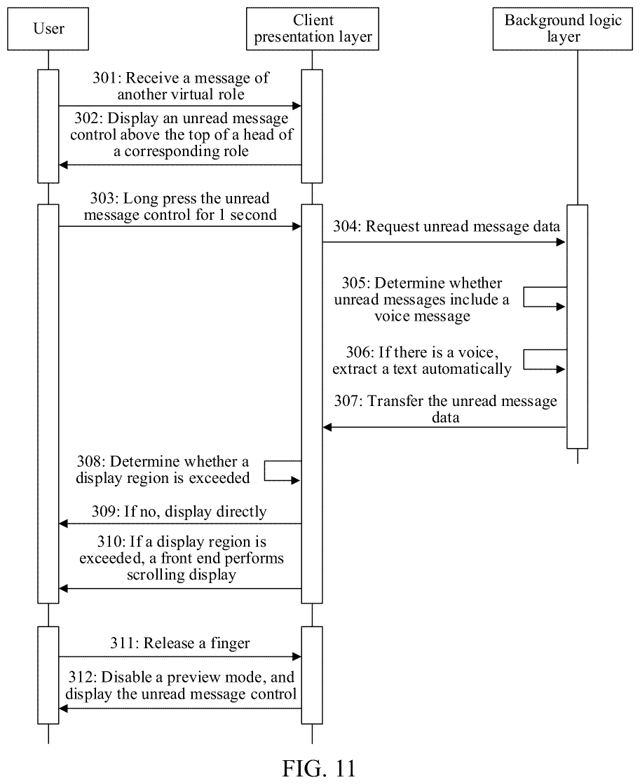

FIG. 10 and FIG. 11 each are a schematic flowchart of a message preview method in a virtual social scene according to an embodiment of this disclosure. With reference to FIG. 10 and FIG. 11, the message preview method in a virtual social scene provided in embodiments of this disclosure includes:

Operation 201: A terminal receives a message of another virtual role.

Herein, the terminal is provided with a virtual social scene client, or a client having a virtual social scene function. Operation 201 corresponds to operation 301 in FIG. 11. During actual application, after the terminal (a client presentation layer) displays a virtual social scene including a plurality of virtual roles, when a current login account receives a message transmitted from another virtual role in the virtual social scene, a prompt of an unread message (that is, the foregoing message prompt control configured to indicate that there is an unread message) is displayed above the top of a head of a corresponding virtual role. This corresponds to operation 302 in FIG. 11, that is, the client presentation layer displays an unread message control (that is, the message prompt control) above the top of the head of the corresponding virtual role.

Operation 202: A user long presses a prompt of an unread message.

Herein, operation 202 corresponds to operation 303 in FIG. 11. After the terminal (the client presentation layer) displays the prompt of the unread message, the user may tap or long press the prompt. The term “long press” means that the user performs a press operation on the prompt of the unread message, and press duration of the press operation reaches target duration (for example, 1 second). If the user taps the prompt of the unread message, the terminal opens a chat details page. If the user long presses the prompt of the unread message for more than 1 second, the terminal is triggered to enter a message preview mode, and then transmits a content obtaining request of the unread message to a server (that is, a background logic layer) to request unread message data (content of the unread message). This corresponds to operation 304 in FIG. 11.

Operation 203: The terminal determines whether unread messages include a voice message, and if yes, performs operation 204, or if no, performs operation 205.

During actual application, an operation of determining whether the unread messages include the voice message may be implemented by the terminal or the server (that is, the background logic layer). When the operation is implemented by the server (that is, the background logic layer), operation 203 corresponds to operation 305 in FIG. 11.

Operation 204: The terminal converts the voice message into a text.

Herein, an operation of converting the voice message into the text may be implemented by the terminal or the server (that is, the background logic layer). When the operation is implemented by the server (that is, the background logic layer), operation 204 corresponds to operation 306 in FIG. 11. To be specific, the server (that is, the background logic layer) extracts the text in the voice message and returns content of the unread message to the terminal, that is, operation 307 in FIG. 11 is performed.

Operation 205: The terminal determines whether a display region is exceeded, and if no, performs operation 206, or if yes, performs operation 207.

Herein, operation 205 corresponds to operation 308 in FIG. 11. The terminal determines whether a display region required for text content of a currently to-be-displayed unread message exceeds a size of a message preview box, to further determine a manner of presenting the text content.

Operation 206: The terminal displays content of all messages.

Herein, operation 206 corresponds to operation 309 in FIG. 11. When the message preview box is large enough to display content of all unread messages, the terminal directly displays the content of all the unread messages in the message preview box.

Operation 207: The terminal enables circular scrolling display, and after reaching a bottom, stays for 3 seconds to re-scroll.

Herein, operation 207 corresponds to Operation 310 in FIG. 11. When the message preview box is not large enough to display content of all unread messages, the content of the unread messages is displayed in a scrolling manner. The terminal first displays content of at least one recently received unread message, and then scrolls down to display content of a historical unread message compared with the message preview box. An operation of the user sliding down a page to view the content of the historical message is simulated, so that the user does not need to scroll actively, and scrolling display of the unread message content is automatically performed, improving message preview experience of the user.

Operation 208: The user releases a finger.

Herein, operation 208 corresponds to operation 311 in FIG. 11. When the user releases the finger, that is, releases a long press operation, the terminal exits a preview mode, and cancels displaying the content of the unread message and redisplays the prompt of the unread message. This corresponds to operation 312 in FIG. 11. To be specific, the terminal (the client presentation layer) disables the preview mode, and displays the unread message control.

Operation 209: The user taps a prompt of an unread message.

Operation 210: The terminal opens chat details.

Herein, when the user taps the prompt of the unread message displayed by the terminal, in response to the tapping operation, the terminal performs a page jump to a chat details page, and displays content of the unread message transmitted by the another virtual role, and content of a historical chat message between the current virtual role and another virtual role in the chat details page.

According to the foregoing embodiment of this disclosure, the content of the unread message is previewed in the page of the current virtual social scene, without requiring the terminal to perform a page jump to the chat details page. That is, the user can view content all messages without entering the chat details page. This improves efficiency of viewing the content of the message and ensures that the user does not miss information in the virtual social scene in a process of previewing the content of the message. The message preview operation is implemented based on the message prompt control, so that a display resource of the terminal does not need to be additionally occupied, improving utilization of the display resource of the terminal. When there is a voice message in the unread messages, for a voice that is inconvenient to be viewed, the voice is converted to a text and then arranged with a text message of the voice. Because the user cannot tap the voice to listen during a long press, the conversion to the text ensures that a reading process is not interrupted.

The following continues to describe that the message preview apparatus 555 in a virtual social scene provided in embodiments of this disclosure is implemented as an example structure of a software module. In some embodiments, the message preview apparatus in a virtual social scene provided in embodiments of this disclosure includes:
a first display module 5551, configured to display at least two virtual images in a page of the virtual social scene,
the virtual image being capable of moving in the virtual social scene, and the virtual image being capable of changing a relative positional relationship with another virtual image when moving in the virtual social scene;
a second display module 5552, configured to: when a message transmitted by the target virtual image in the at least two virtual images is received, display a message prompt control configured to indicate that there is an unread message in the virtual social scene; and
a switching module 5553, configured to: in response to a message preview operation on the message prompt control, switch displaying the message prompt control to displaying content of the unread message.

In some embodiments, the switching module is further configured to: when the message preview operation is a press operation on the message prompt control, and the press operation meets a message preview condition, cancel displaying the message prompt control, and
in a process of performing the press operation, display the content of the unread message in a target orientation of the target virtual image.

In some embodiments, the switching module is further configured to: after the content of the unread message is displayed, when the press operation is released, cancel displaying the content of the unread message, and display the message prompt control again in the target orientation of the target virtual image.

In some embodiments, the switching module is further configured to: when the message preview operation is a trigger operation on the message prompt control, cancel displaying the message prompt control, and
display the content of the unread message in the target orientation of the target virtual image; and when display duration of the content reaches first duration, cancel displaying the content of the unread message.

In some embodiments, the switching module is further configured to: cancel displaying the message prompt control; and display a message preview box in the target orientation of the target virtual image, and display the content of the unread message in the message preview box.

In some embodiments, the switching module is further configured to: when a display area required for the content of the unread message is not greater than a display area of the message preview box, directly display the content of the unread message in the message preview box; or
when a display area required for the content of the unread message is greater than a display area of the message preview box, display the content of the unread message in the message preview box in a scrolling manner.

In some embodiments, the switching module is further configured to: display a first part of content of the unread message in the message preview box;
scroll the first part of content to cause the first part of content to gradually disappear from the message preview box; and
gradually display a second part of content of the unread message in a process of scrolling the first part of content, where receiving time of the second part of content is earlier than receiving time of the first preview box.

In some embodiments, the switching module is further configured to: for a first unread message and a second unread message that are adjacent in receiving time in the at least two unread messages, display content of the first unread message in the message preview box, and
when display duration of the content of the first unread message reaches second duration, control the first unread message to move out of the message preview box and disappear; and
when the first unread message is moved out of the message preview box, control the second unread message to move in the message preview box, and display content of the second unread message in the message preview box.

In some embodiments, the switching module is further configured to: cancel displaying the message prompt control, and when the unread message is an unread voice message, display, in the target orientation of the target virtual image, a voice identifier of the unread voice message and text content that is obtained by performing text conversion on the unread voice message.

In some embodiments, the apparatus further includes a play module, configured to play voice content of the unread voice message in a process of displaying the text content.

In some embodiments, the first display module is further configured to: display, in the page of the virtual social scene, at least one virtual image that does not include the target virtual image;
when a message transmitted by the target virtual image is received, display the target virtual image in the page of the virtual social scene; and determine the target virtual object and the at least one virtual image as the at least two virtual images.

In some embodiments, the second display module is further configured to: after displaying the message prompt control is switched to displaying the content of the unread message, display a quick reply control for the unread message, where the quick reply control is configured to quickly reply to the unread message.

In some embodiments, the quick reply control is a voice quick reply control, and the apparatus further includes a message reply module, configured to: in response to a press operation on the voice quick reply control, when the press operation meets a trigger condition, perform audio capturing in a process of performing the press operation; and
when the press operation is released, transmit a voice message including captured audio content to the target virtual image.

In some embodiments, the quick reply control is a text quick reply control, and the apparatus further includes a message reply module, configured to: in response to a trigger operation on the text quick reply control, display a message transmitting box and a corresponding transmitting control;

in response to a text editing operation, display edited content in the message transmitting box; and

in response to a message transmitting instruction triggered based on the transmitting control, transmit the edited content to the target virtual image.

In some embodiments, the virtual social scene further includes a virtual group image corresponding to at least one social group, and the virtual group image is a three-dimensional image model configured to represent the social group;
the second display module is further configured to: when a message transmitted by a member in the target social group is received, display, in a target orientation of a target three-dimensional image model corresponding to the target social group, a group message prompt control configured to indicate that there is an unread group message; and
the switching module is further configured to: in response to a message preview operation on the group message prompt control, switch displaying the group message prompt control to displaying content of the unread group message in the target orientation of the target three-dimensional image model.

In some embodiments, the apparatus further includes a play module, configured to: when a quantity of unread messages reaches a quantity threshold, play a message prompt audio, where the message prompt audio is configured for indicating to view the unread message transmitted by the target virtual image.

In some embodiments, the apparatus further includes a detection module, configured to: when the virtual social scene is a virtual social scene based on virtual reality, detect a somatosensory operation for triggering the message prompt control, and determine the somatosensory operation as the message preview operation; or
detect a ray emitting operation on an external device, and when an irradiation position of a ray emitted by the external device corresponds to a target position based on the ray emitting operation, determine the ray emitting operation as the message preview operation, where
the target position is a display position of the message prompt control in the virtual social scene.

An embodiment of this disclosure provides an electronic device, including:
a memory, configured to store an executable instruction; and
a processor, configured to implement, when executing the executable instruction stored in the memory, the message preview method in a virtual social scene according to embodiments of this disclosure.

An embodiment of this disclosure provides a computer program product or a computer program. The computer program product or the computer program includes a computer-executable instruction, and the computer-executable instruction is stored in a computer-readable storage medium, such as a non-transitory computer-readable storage medium. A processor of a computer device reads the computer-executable instruction from the computer-readable storage medium, and the processor executes the computer-executable instruction, to cause the computer device to perform the message preview method in a virtual social scene according to embodiments of this disclosure.

An embodiment of this disclosure further provides a computer-readable storage medium, having a computer-executable instruction stored therein. When the computer-executable instruction is executed by a processor, the message preview method in a virtual social scene according to embodiments of this disclosure is implemented.

In some embodiments, the computer-readable storage medium may be a memory such as a read-only memory (ROM), a random access memory (RAM), an erasable programmable read-only memory (EPROM), an electronic erasable programmable read-only memory (EPROM), a flash memory, a disk, a compact disc read-only memory (CD-ROM), or the like; or various devices including any one of the foregoing memories or a combination thereof.

In some embodiments, the executable instruction may be written by using any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit suitable for use in a computing environment.

For example, the executable instruction may, but does not necessarily, correspond to a file in a file system, and may be stored in a part of a file that stores other programs or data, for example, stored in one or more scripts in a hypertext markup language (HTML) file, stored in a single file dedicated to a program in discussion, or stored in a plurality of collaborative files (for example, stored in files of one or more modules, subprograms, or code parts).

For example, the executable instruction may be deployed to be executed on a computer device, or executed on a plurality of computer devices located at a same location, or executed on a plurality of computer devices that are distributed at a plurality of locations and interconnected through a communication network.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely embodiments of this disclosure and are not intended to limit the protection scope of this disclosure. Any modification, equivalent replacement, or improvement made without departing from the spirit and scope of this disclosure shall fall within the protection scope of this disclosure.

What is claimed is:

1. A method for previewing messages in a virtual environment, the method comprising:
displaying a plurality of virtual characters in the virtual environment, each virtual character of the plurality of virtual characters is movable in the virtual environment;
when receiving a message from a first virtual character of the plurality of virtual characters, displaying a message notification graphical element in association with the first virtual character in the virtual environment; and
in response to detecting a user input on the message notification graphical element, displaying content of the received message.

2. The method according to claim 1, wherein the displaying the content of the received message comprises:
when the user input is a press operation on the message notification graphical element and meets a preview condition, cancelling the display of the message notification graphical element; and
when the preview condition is met and while the press operation is being performed, displaying the content of the received message at a target location of the first virtual character.

3. The method according to claim 2, further comprising:
when the press operation ends, canceling the display of the content of the received message; and
displaying the message notification graphical element at the target location of the first virtual character.

4. The method according to claim 1, wherein the displaying the content of the received message comprises:
when the user input is a trigger operation on the message notification graphical element, cancelling the display of the message notification graphical element;
displaying the content of the received message at a target location of the first virtual character; and
cancelling the display of the content of the received message after a predefined duration.

5. The method according to claim 1, wherein the displaying the content of the received message comprises:
canceling the display of the message notification graphical element;
displaying a message preview interface at a target location of the first virtual character; and
displaying the content of the received message within the message preview interface.

6. The method according to claim 5, wherein the displaying the content of the received message within the message preview interface comprises:
when a display area of the content of the received message is less than or equal to a display area of the message preview interface, displaying the content of the received message within the message preview interface; and
when the display area of the content of the received message is greater than the display area of the message preview interface, displaying the content of the received message in a scrolling manner within the message preview interface.

7. The method according to claim 6, wherein the displaying the content of the received message in the scrolling manner comprises:
displaying a first portion of the content of the received message in the message preview interface;
scrolling the first portion of the content of the received message to cause the first portion of the content of the received message to disappear from the message preview interface; and
displaying a second portion of the content of the received message to appear while the first portion of the content of the received message is being scrolled, wherein the second portion of the content of the received message is received earlier than the first portion of the content of the received message.

8. The method according to claim 6, further comprising:
when a plurality of received messages are received,
for a first received message of the plurality of received messages and a second received message of the plurality of received messages that are received sequentially, displaying content of the first received message in the message preview interface;
after a predefined duration, cancelling the display of the content of the first received message from the message preview interface; and
displaying content of the second received message in the message preview interface.

9. The method according to claim 1, wherein the displaying the content of the received message comprises:
when the received message is a voice message, cancelling the display of the message notification graphical element; and
displaying a voice message graphical element and text content, obtained by converting the voice message to text, at a target location of the first virtual character.

10. The method according to claim 9, further comprising:
playing audio content of the voice message when the text content is displayed.

11. The method according to claim 1, further comprising:
when receiving the message from the first virtual character, adding the first virtual character to the display of the plurality of virtual characters in the virtual environment.

12. The method according to claim 1, further comprising:
after the display of the content of the received message, displaying a quick reply control element associated with the received message.

13. The method according to claim 12, wherein the quick reply control element is a voice quick reply control element, and the method further comprises:
in response to detecting a press operation on the voice quick reply control element meets a trigger condition, capturing audio input while the press operation is being performed; and
when the press operation ends, transmitting a voice message including the captured audio input to the first virtual character.

14. The method according to claim 12, wherein the quick reply control element is a text quick reply control element, and the method further comprises:
in response to detecting a trigger operation on the text quick reply control element, displaying a message transmitting interface with a corresponding transmitting control element;
in response to text input, displaying the input text in the message transmitting interface; and
in response to selection of the transmitting control element, transmitting the input text to the first virtual character.

15. The method according to claim 1, wherein the virtual environment further includes at least one virtual group character corresponding to a social group, the virtual group character is a three-dimensional model, and the method further comprises:
when receiving a message from a member of a target social group, displaying a group message notification graphical element associated with the virtual group character corresponding to the target social group; and
in response to detecting a user input applied to the group message notification graphical element, displaying content of the received group message at a target location of the virtual group character.

16. The method according to claim 1, further comprising:
when a number of received messages from the first virtual character reaches a threshold, playing an audio alert to indicate a presence of the received messages from the first virtual character.

17. The method according to claim 1, wherein when the virtual environment is a virtual reality environment, the method further comprises:
detecting a gesture for triggering the message notification graphical element, and determining the detected gesture as the user input on the message notification graphical element; or
detecting a ray emitting operation from an external device, and when a ray intersects with the message notification graphical element, determining the ray emitting operation as the user input on the message notification graphical element.

18. An apparatus, comprising:
processing circuitry configured to:
display a plurality of virtual characters in a virtual environment, each virtual character of the plurality of virtual characters is movable in the virtual environment;
when a message is received from a first virtual character of the plurality of virtual characters, display a message notification graphical element in association with the first virtual character in the virtual environment; and
display content of the received message in response to a detection of a user input on the message notification graphical element.

19. The apparatus according to claim 18, wherein the processing circuitry is configured to:
when the user input is a press operation on the message notification graphical element and meets a preview condition, cancel the display of the message notification graphical element; and
when the preview condition is met and while the press operation is being performed, display the content of the received message at a target location of the first virtual character.

20. A non-transitory computer-readable storage medium, storing instructions which when executed by a processor cause the processor to perform:
displaying a plurality of virtual characters in a virtual environment, each virtual character of the plurality of virtual characters is movable in the virtual environment;
when receiving a message from a first virtual character of the plurality of virtual characters, displaying a message notification graphical element in association with the first virtual character in the virtual environment; and
in response to detecting a user input on the message notification graphical element, displaying content of the received message.
